(19) United States
(12) Patent Application Publication
(10) Pub. No.: US 2026/0070832 A1
(43) Pub. Date: Mar. 12, 2026

(54) METHODS AND APPARATUS FOR MANUFACTURING A RIBBON

(71) Applicant: Corning Incorporated, CORNING, NY (US)

(72) Inventors: Jeffrey Robert Amadon, Lexington, KY (US); Tyler M Burns, Buffalo, NY (US); Geoffrey William Cassell, Lexington, KY (US); William Jason Hill, Lindley, NY (US); Jacob Immerman, Corning, NY (US); William Edward Lock, Horseheads, NY (US); Aniello Mario Palumbo, Painted Post, NY (US); David Posada-Pineda, Elmira, NY (US); Rohit Rai, Lexington, MA (US); Jeremy Adam Renner, Harrodsburg, KY (US); Ljerka Ukrainczyk, Ithaca, NY (US)

(21) Appl. No.: 19/109,785

(22) PCT Filed: Aug. 30, 2023
(86) PCT No.: PCT/US2023/031499

§ 371 Date: Mar. 7, 2025

Related U.S. Application Data
(60) Provisional application No. 63/404,626, filed on Sep. 8, 2022.

(51) Int. Cl. C03B 17/06

(52) U.S. Cl. CPC C03B 17/065

(57) ABSTRACT

A glass manufacturing apparatus includes a delivery apparatus defining an upstream portion of a ribbon travel path extending in a first travel direction. The glass manufacturing apparatus includes a forming roll extending along an axis parallel to the travel path and perpendicular to the first travel direction. The forming roll includes a recess that imparts a protrusion to a ribbon traveling along the ribbon travel path in the first travel direction. The forming roll includes a first surface defining the recess and a first surface characteristic. The forming roll includes a second surface defining an area surrounding the recess and including a second surface characteristic. The first surface characteristic is different than the second surface characteristic. During a cooling period of time, the first surface cools at a faster rate than the second surface. Methods of manufacturing a ribbon are provided.

### CROSS-REFERENCE TO RELATED APPLICATION

This application claims the benefit of priority under 35 U.S.C. § 119 of U.S. Provisional Application Ser. No. 63/404,626 filed on Sep. 8, 2022, the content of which is relied upon and incorporated herein by reference in its entirety.

### FIELD

The present disclosure relates generally to methods for manufacturing a ribbon and, more particularly, to methods for manufacturing a ribbon by cooling portions of the ribbon.

### BACKGROUND

It is known to manufacture molten material into a ribbon of nominally uniform thickness with a glass manufacturing apparatus. A pair of forming rolls can be spaced apart to define a gap that can receive the molten material. The molten material can pass through the gap, whereupon the molten material can be formed into a ribbon of nominally uniform thickness. Sheets from such ribbon can then be cut into smaller parts and finished into a glass article of non-uniform thickness distribution by grinding, machining, and/or polishing the ribbon. However, the grinding, machining, and/or polishing process is inefficient and costly when the formed sheets have uniform thickness whereas the finished glass article has significant thickness variation. It is possible to reduce finishing costs and improve material utilization by forming glass sheets of non-uniform thickness by passing the molten glass through shaped rolls, e.g. rolls with grooves or pockets. However, adding grooves or pockets or other such features on the forming rolls, to create sheets of desired thickness variation, can create several challenges. For example, temperature difference between the thick and thin portions of the glass ribbon may be significant and may lead to high stresses and warp. Mitigating these defects in the variable thickness sheet in the rolling process can be challenging, requiring significant increase in equipment complexity, cost, and footprint.

### SUMMARY

The following presents a simplified summary of the disclosure to provide a basic understanding of some aspects described in the detailed description.

There are set forth methods of manufacturing a ribbon comprising forming a ribbon of variable thickness. For example, the ribbon can comprise a thick portion (e.g., a protrusion) and a thin portion (e.g., a ribbon portion surrounding the protrusion). During the manufacturing process, a temperature gradient between the thick portion and the thin portion of the ribbon can arise. Several methods are described herein for reducing this temperature gradient. For example, local cooling can be applied to the thick portion by air or an aerosol directed toward the thick portion. In addition, or in the alternative, a forming roll can be hollow and filled with a cooling fluid, such that the forming roll can extract a greater amount of heat from the thick portion than the thin portion. In addition, or in the alternative, multiple sets of forming rolls can be provided to contact the thick portion, thus further extracting heat. By reducing a temperature difference between the thick portion and the thin portion, several effects can be avoided, for example, back-protrusion of ribbon, deformation of the ribbon, and excess stress and warpage of the ribbon.

Aspect 1. A glass manufacturing apparatus comprising:
a delivery apparatus defining an upstream portion of a ribbon travel path extending in a first travel direction;
a forming roll extending along an axis that is parallel to the travel path and perpendicular to the first travel direction, the forming roll comprising a recess configured to impart a protrusion to a ribbon traveling along the ribbon travel path in the first travel direction, the forming roll comprising:
   a first surface defining the recess and comprising a first surface characteristic;
   a second surface defining an area surrounding the recess and comprising a second surface characteristic, the first surface characteristic different than the second surface characteristic wherein, during a cooling period of time, the first surface is configured to cool at a faster rate than the second surface.

Aspect 2. The glass manufacturing apparatus of aspect 1, wherein the first surface characteristic comprises a first surface roughness and the second surface characteristic comprises a second surface roughness, the first surface roughness less than the second surface roughness.

Aspect 3. The glass manufacturing apparatus of any one of aspects 1-2, wherein the first surface characteristic comprises a third surface roughness different from the first surface roughness.

Aspect 4. The glass manufacturing apparatus of any one of aspects 1-3, wherein the forming roll is hollow and the first surface characteristic comprises a first wall thickness and the second surface characteristic comprises a second wall thickness, the first wall thickness less than the second wall thickness.

Aspect 5. The glass manufacturing apparatus of any one of aspects 1-4, wherein the first surface characteristic comprises a first thermal conductivity and the second surface characteristic comprises a second thermal conductivity, the first thermal conductivity greater than the second thermal conductivity.

Aspect 6. The glass manufacturing apparatus of any one of aspects 1-5, wherein the forming roll comprises a hollow chamber comprising a liquid.

Aspect 7. The glass manufacturing apparatus of any one of aspects 1-6, further comprising a cooling apparatus comprising a cooling mechanism to cool the protrusion, the cooling apparatus comprising a dispenser, and the cooling mechanism comprising one or more of air or an aerosol directed from the dispenser toward the protrusion.

Aspect 8. The glass manufacturing apparatus of any one of aspects 1-7, further comprising a second forming roll positioned one of downstream or upstream from the forming roll, the second forming roll configured to cool the ribbon and flatten the protrusion.

Aspect 9. A glass manufacturing apparatus comprising:
a delivery apparatus defining an upstream portion of a ribbon travel path extending in a first travel direction;
a forming roll extending along an axis that is parallel to the travel path and perpendicular to the first travel direction, the forming roll comprising a recess configured to impart a protrusion to a ribbon traveling along the ribbon travel path in the first travel direction;
a turning roll downstream from the forming roll and extending along an axis that is parallel to the travel path, the turning roll configured to direct the ribbon along the ribbon travel path in a second travel direction that is non-parallel to the first travel direction; and
a cooling apparatus positioned downstream from the forming roll and upstream from the turning roll, the cooling apparatus comprising a cooling mechanism to cool the protrusion, and wherein, during a cooling period of time, the protrusion is configured to cool at a faster rate than a ribbon portion of the ribbon surrounding the protrusion.

Aspect 10. The glass manufacturing apparatus of aspect 9, wherein the forming roll comprises a first surface defining the recess and comprising a first surface characteristic, and a second surface defining an area surrounding the recess and comprising a second surface characteristic, the first surface characteristic different than the second surface characteristic wherein, during the cooling period of time, the first surface is configured to cool at a faster rate than the second surface.

Aspect 11. The glass manufacturing apparatus of any one of aspects 9-10, wherein the cooling apparatus comprises a dispenser, and the cooling mechanism comprises one or more of air or an aerosol directed from the dispenser toward the protrusion.

Aspect 12. The glass manufacturing apparatus of any one of aspects 9-11, wherein the cooling apparatus comprises a plate comprising a hollow chamber within which a liquid is stored, the plate positioned adjacent to the protrusion.

Aspect 13. The glass manufacturing apparatus of aspects 9-12, wherein the cooling mechanism comprises a first surface portion of the plate in contact with the protrusion.

Aspect 14. The glass manufacturing apparatus of any one of aspects 9-13, further comprising a support surface positioned downstream from the turning roll, the support surface configured to support the ribbon, the support surface comprising a non-planar shape.

Aspect 15. The glass manufacturing apparatus of any one of aspects 9-14, further comprising a second forming roll positioned one of downstream or upstream from the forming roll, the second forming roll configured to cool the ribbon and flatten the protrusion.

Aspect 16. Methods of manufacturing a ribbon comprising:
contacting the ribbon with a recess of a forming roll to impart a protrusion to the ribbon traveling along a ribbon travel path in a first travel direction;
reducing a temperature difference between the protrusion and a ribbon portion of the ribbon surrounding the protrusion.

Aspect 17. Methods of aspect 16, wherein the reducing the temperature difference comprises cooling the protrusion at a faster rate than cooling the ribbon portion.

Aspect 18. Methods of any one of aspects 16-17, wherein the reducing the temperature difference comprises directing a material toward the protrusion to cool the protrusion, the directing occurring at a location downstream from the imparting of the protrusion.

Aspect 19. Methods of any one of aspects 16-18, wherein the reducing the temperature occurs as the protrusion is imparted and the ribbon contacts the forming roll.

Aspect 20. Methods of any one of aspects 16-19, further comprising cooling the forming roll by providing a liquid to a hollow chamber of the forming roll.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a glass manufacturing apparatus in accordance with aspects of the disclosure;

FIG. 2 illustrates a sectional view along lines 2-2 of FIG. 1 of a forming roll in accordance with aspects of the disclosure;

FIG. 3 illustrates a sectional view similar to FIG. 2 of additional aspects of a forming roll in accordance with aspects of the disclosure;

FIG. 4 illustrates a cooling apparatus for cooling the ribbon in accordance with aspects of the disclosure;

FIG. 5 illustrates a cooling apparatus for cooling the ribbon in accordance with aspects of the disclosure;

FIG. 6 illustrates a cooling apparatus for cooling the ribbon in accordance with aspects of the disclosure;

FIG. 7 illustrates a cooling apparatus for cooling the ribbon in accordance with aspects of the disclosure;

FIG. 8 illustrates a body and a support surface for supporting the ribbon in accordance with aspects of the disclosure;

FIG. 9 illustrates a plurality of sets of forming rolls in accordance with aspects of the disclosure;

FIG. 10 illustrates a plurality of sets of forming rolls in accordance with aspects of the disclosure;

FIG. 11 illustrates a plurality of sets of forming rolls in accordance with aspects of the disclosure;

FIG. 12 illustrates a forming roll in contact with the ribbon in accordance with aspects of the disclosure;

FIG. 13 illustrates protrusions formed in the ribbon in accordance with aspects of the disclosure;

FIG. 14 illustrates protrusions formed in the ribbon in accordance with aspects of the disclosure; and FIG. 15 illustrates protrusions formed in the ribbon in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic relative to arrangement of steps, operational flow, order of components, or orientation of components; plain meaning derived from grammatical organization or punctuation, and; the number or type of aspects described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B (e.g., two different ends).

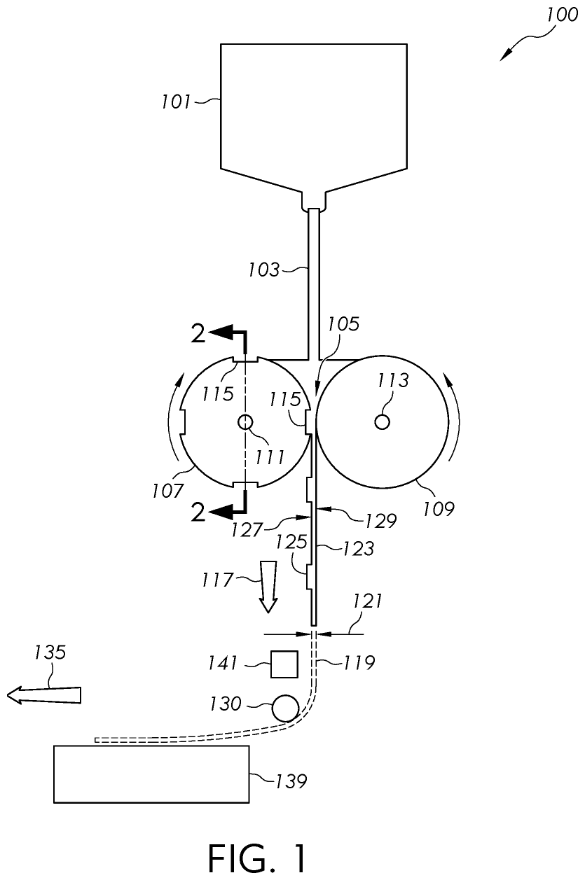

The present disclosure relates to a glass manufacturing apparatus and methods for forming a ribbon. For purposes of this application, “ribbon” may be considered one or more of a ribbon in a viscous state, a ribbon in an elastic state (e.g., at room temperature) and/or a ribbon in a viscoelastic state between the viscous state and the elastic state. The ribbon may comprise a ribbon of an indeterminate length or one or more separated glass articles (e.g., separated ribbons, separated sheets, etc.) that comprise four discrete edges. Methods and apparatus for manufacturing a ribbon will now be described by way of example aspects. As schematically illustrated in FIG. 1, in aspects, an exemplary glass manufacturing apparatus 100 can comprise a delivery apparatus 101 with a delivery conduit through which a stream of molten glass 103 can exit the delivery apparatus 101. For example, the delivery apparatus 101 can comprise an elongated passageway with an opening at the end of the delivery apparatus 101. In aspects, the delivery apparatus 101 can be oriented along a direction of gravity, such that the stream of molten glass 103 can flow downwardly along the direction of gravity from the delivery apparatus 101.

In aspects, the delivery apparatus 101 can define an upstream portion of a ribbon travel path 119 extending in a first travel direction 117. The delivery apparatus 101 can convey the stream of molten glass 103 along the ribbon travel path 119 in the first travel direction 117. In aspects, the glass manufacturing apparatus 100 can comprise one or more pairs of opposing forming rolls, for example, a first forming roll 107 and a second forming roll 109. The second forming roll 109 may be spaced from the first forming roll 107 to define a gap 105. The gap 105 provides a ribbon 123 with a width and a thickness 121. In aspects, the first forming roll 107 and the second forming roll 109 can rotate counter to one another. For example, in the orientation shown in FIG. 1, the first forming roll 107 can rotate in a clockwise direction while the second forming roll 109 can rotate in a counter-clockwise direction. In aspects, the first forming roll 107 and the second forming roll 109 can receive the stream of molten glass 103 along the travel path 119 within the gap 105. The stream of molten glass 103 can accumulate between the first forming roll 107 and the second forming roll 109, whereupon the first forming roll 107 and the second forming roll 109 can flatten, thin, and smooth the stream of molten glass 103 into the ribbon 123.

In aspects, the first forming roll 107 can extend along an axis 111 that is parallel to the travel path 119 and perpendicular to the first travel direction 117. The second forming roll 109 can extend along an axis 113 that is parallel to the travel path 119 and perpendicular to the first travel direction 117. In aspects, one or more of the first forming roll 107 or the second forming roll 109 can comprise a textured feature that may impart a corresponding textured feature to the ribbon 123. For example, in aspects, the textured feature of the forming roll(s) 107, 109 can comprise, for example, projections (e.g., extensions, outcroppings, etc.), recesses (e.g., openings, channels, etc.). As illustrated and described relative to FIG. 1, the textured feature of the first forming roll 107 can comprise a recess 115 that can impart a protrusion 125 to the ribbon 123 traveling along the ribbon travel path 119 in the first travel direction 117. The recess 115 can be formed at an outer surface of the first forming roll 107. For example, the first forming roll 107 can comprise a substantially circular cross-sectional shape. Accordingly, a radial distance from a center of the first forming roll 107 to the recess 115 may be less than a radial distance from a center of the first forming roll 107 to the outer surface of the first forming roll 107 at a location of the first forming roll 107 at which the recess 115 is not present. In aspects, additional recesses 115 can be spaced apart about a circumference of the first forming roll 107. In aspects, the recess 115 may cover the full circumference of the first forming roll 107, for example, to form strips instead of patches of thicker glass. In addition, or in the alternative, additional recesses can be located at differing locations about the axis 111 (e.g., which goes through the center of the first forming roll 107) of the first forming roll 107.

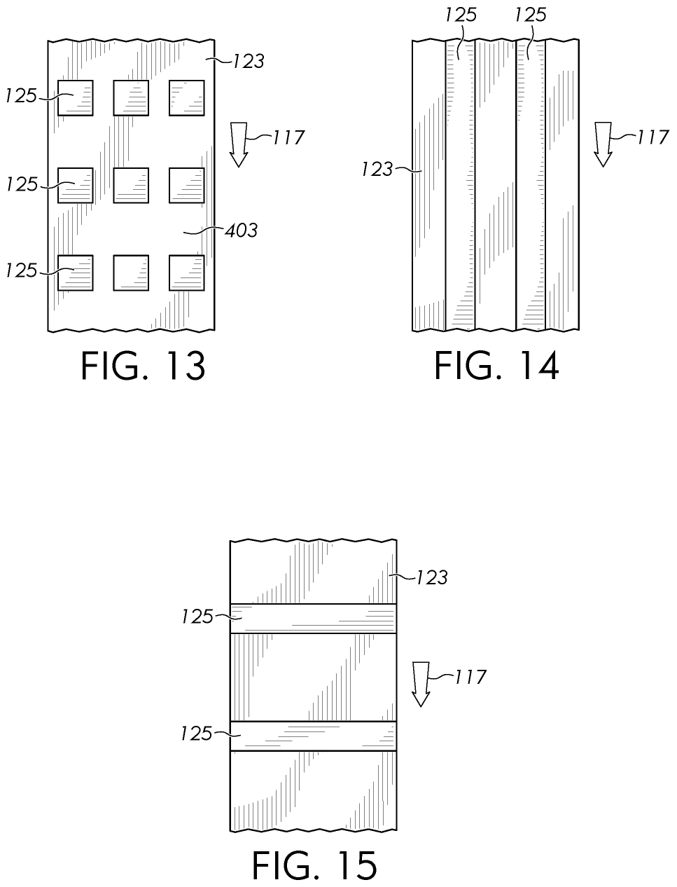

In aspects, the recess 115 can impart a corresponding textured feature, for example, the protrusion 125, to the ribbon 123. For example, as the stream of molten glass 103 travels through the gap 105, the stream of molten glass 103 can contact the first forming roll 107 and the second forming roll 109 such that the ribbon 123 can be formed and may exit the gap 105. In aspects, the contact between the first forming roll 107 and the ribbon 123 can impart the protrusion 125 to the ribbon 123. The ribbon 123 can contact the first forming roll 107 and may engage the recess 115, for example, with hot glass flowing into the recess 115. As a result, the recess 115 can cause the corresponding protrusion 125 in a first major surface 127 of the ribbon 123. The protrusion 125 may comprise a thicker area of the ribbon 123 as compared to locations immediately upstream and downstream from the protrusion 125. Accordingly, in aspects, methods of manufacturing the ribbon 123 can comprise contacting the ribbon 123 with the recess 115 of the first forming roll 107 to impart the protrusion 125 to the first major surface 127 of the ribbon 123 traveling along the ribbon travel path 119 in the first travel direction 117. Examples of some, but not all, of the shapes of the protrusions 125 are illustrated and described relative to FIGS. 13-15.

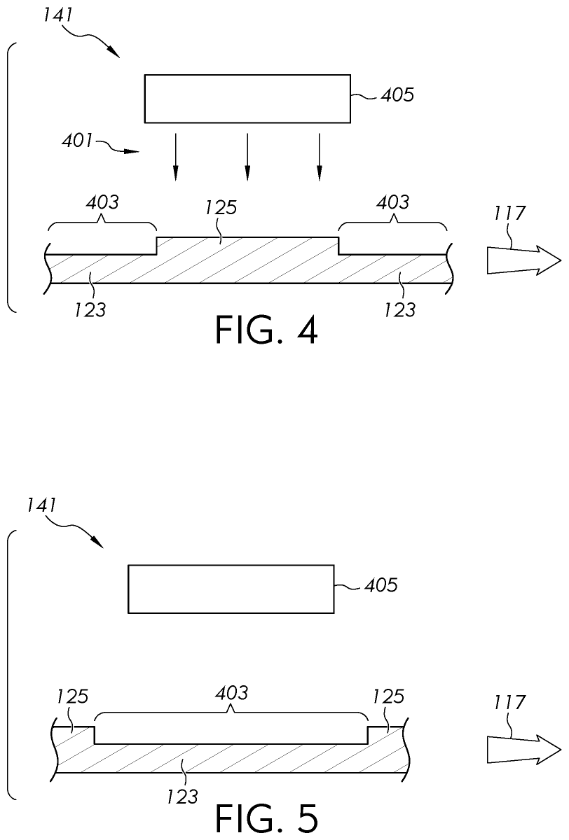

A turning roll 130 may be located downstream from the forming rolls 107, 109 relative to the first travel direction 117 to change the travel direction of the travel path 119. For example, the turning roll 130 can direct the ribbon 123 to turn about 90 degrees such that the ribbon 123 can move from a substantially vertical orientation upstream from the turning roll 130 to a horizontal orientation downstream from the turning roll 130. The turning roll 130 can extend along an axis that is parallel to the travel path 119, with the turning roll 130 configured to direct the ribbon 123 along the ribbon travel path 119 in a second travel direction 135 that is non-parallel to the first travel direction 117. In aspects, a support surface 139 can be positioned downstream from the turning roll 130 (e.g., relative to a travel direction of the ribbon 123), with the support surface 139 configured to support the ribbon 123. In aspects, the support surface 139 can comprise a conveyor (e.g., a belt conveyor), one or more air bearings, one or more rollers, etc. In aspects, a cooling apparatus 141 can be positioned downstream from the forming rolls 107, 109 and upstream from the turning roll 130. The cooling apparatus 141 (e.g., illustrated and described in FIGS. 4-7) can cool portions of the ribbon 123.

In aspects, the ribbon 123 may comprise glass (e.g., a glass substrate or a glass ribbon), for example, one or more of soda-lime glass, borosilicate glass, alumino-borosilicate glass, alkali-containing glass, alkali-free glass, aluminosilicate, borosilicate, boroaluminosilicate, silicate, glass-ceramic, or other materials comprising glass. In aspects, the ribbon 123 can comprise one or more of lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials. The ribbon 123 can alternatively comprise a ceramic, polymer, metal, multi-layer stack, or a composite of materials. The ribbon 123 can comprise several shapes, for example, square shapes, rectangular shapes, hexagonal shapes, irregular shapes, etc. In aspects, the ribbon 123 can be employed in a variety of display and non-display applications comprising, but not limited to, liquid crystal displays (LCDs), electrophoretic displays (EPD), organic light emitting diode displays (OLEDs), plasma display panels (PDPs), microLED displays, miniLED displays, organic light emitting diode lighting, light emitting diode lighting, augmented reality (AR), virtual reality (VR), touch sensors, photovoltaics, foldable phones, or other applications. In aspects, the ribbon 123 can be used as a back-glass cover for a smartphone or other glass body for electronic component that has a non-uniform thickness (e.g., with a thicker portion or protrusion 125 of the glass at a camera region to enable improved camera lens designs).

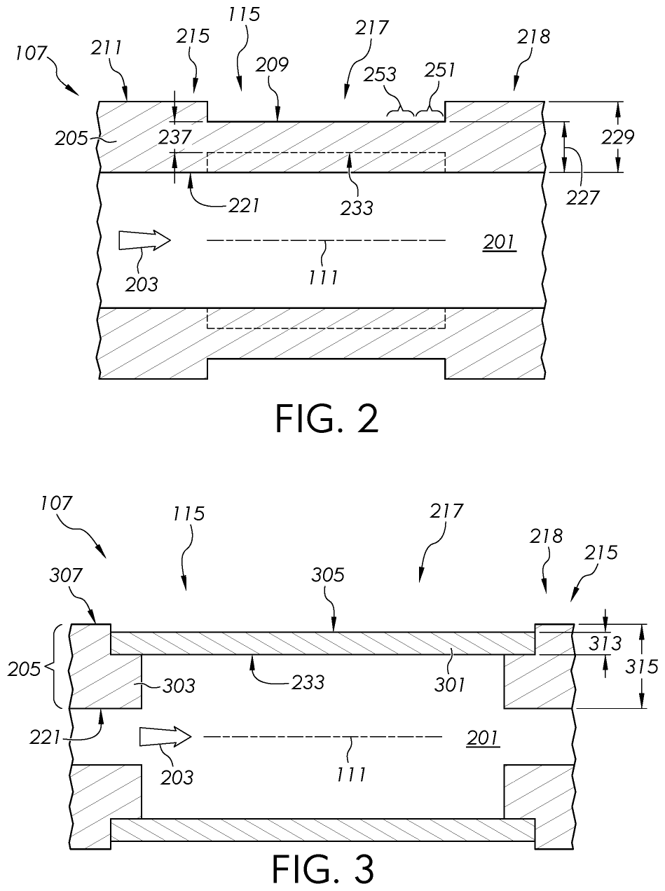

FIG. 2 illustrates a sectional view of a portion of the first forming roll 107 along lines 2-2 of FIG. 1. In aspects, the first forming roll 107 may comprise a hollow chamber 201 comprising a liquid 203 (e.g., illustrated schematically with arrowhead). The first forming roll 107 comprises a wall 205 that defines the hollow chamber 201, with the wall 205 forming a substantially circular cross-sectional shape. The wall 205 can extend along, and may be coaxial with, the axis 111, with the wall 205 extending circumferentially about the hollow chamber 201. The first forming roll 107 comprises a first surface 209 and a second surface 211, with the first surface 209 and the second surface 211 defining an outer radial location of the wall 205. In aspects, the first surface 209 can define the recess 115 and may comprise a first surface characteristic 217. The second surface 211 can define an area 215 surrounding the recess 115 and comprising a second surface characteristic 218. In this way, the first surface 209 and the second surface 211 may be substantially parallel and offset, with a distance separating the first surface 209 and the axis 111 less than a distance separating the second surface 211 and the axis 111. In aspects, the surface characteristics can comprise differences between the first surface 209 and the second surface 211 that affect a rate of heat transfer from the molten glass 103 to the first forming roll 107 when the ribbon 123 is formed. As such, the first surface characteristic 217 may be different than the second surface characteristic 218.

The first forming roll 107 comprises a third surface 221 defining an inner radial location of the wall 205 that borders the hollow chamber 201. In aspects, the wall 205 can comprise a non-constant thickness along the axis 111. For example, at a first location, the wall 205 can comprise a first wall thickness 227 between the third surface 221 and the first surface 209 (e.g., measured along a direction that is substantially perpendicular to the axis 111). At a second location, the wall 205 can comprise a second wall thickness 229 between the third surface 221 and the second surface 211 (e.g., along a direction that is substantially perpendicular to the axis 111). In aspects, the first wall thickness 227 may be within a range from about 2 mm to about 5 mm, or about 3 mm, and the second wall thickness 229 may be within a range from about 7 mm to about 10 mm.

In aspects, the first surface characteristic 217 can comprise the first wall thickness 227 and the second surface characteristic 218 can comprise the second wall thickness 229, with the first wall thickness 227 less than the second wall thickness 229. The first and second surface characteristics 217, 218 (e.g., the first wall thickness 227 and the second wall thickness 229) can cause a differing rate of heat transfer for portions of the ribbon 123 that are in contact with the first surface 209 as compared to portions of the ribbon 123 that are in contact with the second surface 211. For example, the liquid 203 within the hollow chamber 201 can comprise a cooling fluid, for example, water, that may be at a lower temperature than the wall 205 and the molten glass 103. The wall 205 can comprise a material with a relatively high thermal conductivity, for example, stainless steel material, an Inconel material, a graphite material, a silica material, etc., such that the liquid 203 can cool the wall 205 by thermal conduction. As the molten glass 103 contacts the first forming roll 107 and the ribbon 123 is formed, the first forming roll 107 may reduce a temperature of the ribbon 123 due to heat transfer from the ribbon 123 to the first forming roll 107, due to the wall 205 being at a lower temperature than the ribbon 123. Due to the wall 205 comprising the first wall thickness 227 at the first surface 209, which is less than the second wall thickness 229 at the second surface 211, a greater amount of heat may be extracted from the portion of the ribbon 123 in contact with the first surface 209 than the portion of the ribbon 123 in contact with the second surface 211. For example, the protrusion 125 can lie within the recess 115 and may be in contact with the first surface 209, and a ribbon portion of the ribbon 123 surrounding the protrusion 125 may be in contact with the second surface 211. Due to the surface characteristics of the first forming roll 107 (e.g., the difference in wall thickness 227, 229), during a cooling period of time, the first surface 209 can cool at a faster rate than the second surface 211. The cooling period of time can comprise the period of time during which the molten glass 103 is in contact with the wall 205 and the ribbon 123 is formed.

In aspects, to further facilitate heat transfer from the protrusion 125, the wall 205 may comprise a non-constant radius separating the axis 111 and the third surface 221 (e.g., inner radial surface) along the axis 111. For example, in aspects, the wall 205 can comprise a fourth surface 233 (e.g., illustrated with dashed lines) defining an inner radial location of the wall 205 that borders the hollow chamber, with the fourth surface 233 laterally offset from the third surface 221 along the axis 111. The fourth surface 233 is illustrated with dashed lines in FIG. 2 because, in aspects, the fourth surface 233 may or may not be present. For example, in aspects, the third surface 221 can be substantially constant in spacing from the axis 111, as illustrated by the unbroken, non-dashed line of the third surface 221. In the alternative, the wall 205 can comprise the fourth surface 233, in which the fourth surface 233 projects toward the first surface 209. Accordingly, at a first location, the third surface 221 can be separated a first radial distance from the axis 111, and at a second location, the fourth surface 233 can be separated a second radial distance from the axis 111, with the second radial distance greater than the first radial distance. The fourth surface 233 can be at the same location as the first surface 209 along the axis 111 such that an intersecting axis perpendicular to the axis 111 can intersect the first surface 209 and the fourth surface 233. In this way, the first surface characteristic 217 may comprise a third wall thickness 237, which is a distance separating the first surface 209 and the fourth surface 233, with the third wall thickness 237 less than the first wall thickness 227 and the second wall thickness 229. With the first surface characteristic comprising the third wall thickness 237 (e.g., as opposed to the first wall thickness 227), additional heat transfer and cooling of the protrusion 125 can be achieved. In aspects, zero, some, or all, of the recesses 115 in the first forming roll 107 can comprise the fourth surface 233, and, thus, the third wall thickness 237.

In aspects, the surface characteristics 217, 218 are not limited to thickness variations of the wall 205. In addition, or in the alternative, the surface characteristics 217, 218 can comprise a differing surface roughness of the first surface 209 and the second surface 211. For example, the first surface characteristic 217 can comprise a first surface roughness of the first surface 209, and the second surface characteristic 218 can comprise a second surface roughness of the second surface 211. In aspects, the first surface roughness may be less than the second surface roughness. The surface roughness may be quantified as Ra, which is the arithmetic average of the absolute values of profile height deviations from a median line (e.g., measurement of peaks and valleys), with a higher Ra value (e.g., indicating a higher surface roughness) producing less efficient heat transfer from the ribbon 123 to the first forming roll 107 and a lower Ra value producing more efficient heat transfer. In this way, a smoother first surface 209 (e.g., and, thus, lower Ra) and a rougher second surface 211 (e.g., and, thus higher Ra) can facilitate a greater heat transfer at the protrusion 125 than at the ribbon portions surrounding the protrusion 125. In this way, a thermal gradient between the protrusion 125 and the ribbon portion surrounding the protrusion 125 can be reduced. In aspects, the first surface 209 can comprise an as-finished surface roughness, and the second surface 211 can comprise an F100 or an F54 finish. F100 and F54 can comprise grit sizes used to obtain a specific surface roughness, for example with F100 comprising a finer sand than F54. In aspects, a “smooth” surface can comprise an Rₐ that is less than about 1 micron, and a “rough” surface can comprise an Rₐ that is greater than about 1 micron, for example, within a range from about 1 micron to about 10 microns.

In addition, or in the alternative, in aspects, the first surface 209 may comprise a non-constant surface roughness. For example, a first surface portion 251 of the first surface 209 may comprise the first surface roughness, and a second surface portion 253 of the first surface 209 may comprise a third surface roughness. In this way, the first surface characteristic 217 can comprise the first surface roughness and the third surface roughness, with the third surface roughness different from the first surface roughness. In aspects, the varying surface roughness can form a grid pattern within the first surface 209, with the varying surface roughness (e.g., the first surface roughness and the third surface roughness), reducing the likelihood of the protrusion 125 adhering to the first surface 209 while still providing an increased heat transfer coefficient as compared to the second surface 211.

FIG. 3 illustrates the first forming roll 107 comprising a plurality of materials. For example, the first forming roll 107 can comprise the wall 205 comprising a first wall portion 301 comprising a first material, and a second wall portion 303 comprising a second material different than the first material. The wall 205 can define the hollow chamber 201 comprising the liquid 203. In aspects, the first wall portion 301 can be attached to the second wall portion 303 by initially forming an opening through the second wall portion 303, with the first wall portion 301 sized to be received within the opening of the second wall portion 303. In aspects, the first wall portion 301 and the second wall portion 303 can be attached such that the first wall portion 301 is fixed and static relative to the second wall portion 303. The first wall portion 301 can comprise a first surface 305 and the second wall portion 303 can comprise a second surface 307, with the first surface 305 and the second surface 307 defining an outer radial location of the wall 205. The first surface 305 defines the recess 115 and may comprise the first surface characteristic 217. The second surface 307 can define the area 215 surrounding the recess 115 and can comprise the second surface characteristic 218. In aspects, the first surface 305 and the second surface 307 may be substantially parallel and offset, with a distance separating the first surface 305 and the axis 111 less than a distance separating the second surface 307 and the axis 111.

The first forming roll 107 can comprise the third surface 221 and the fourth surface 233 defining the inner radial location of the wall 205 that borders the hollow chamber 201. In aspects, the wall 205 can comprise a non-constant thickness along the axis 111. For example, at a first location, the wall 205 can comprise a first wall thickness 313 between the fourth surface 233 and the first surface 305 (e.g., along a direction that is substantially perpendicular to the axis 111). At a second location, the wall 205 can comprise a second wall thickness 315 between the third surface 221 and the second surface 307 (e.g., along a direction that is substantially perpendicular to the axis 111).

In aspects, the first surface characteristic 217 can comprise the material of the first wall portion 301 (e.g., comprising the first surface 305) and the second surface characteristic 218 can comprise the material of the second wall portion 303 (e.g., comprising the second surface 307). In aspects, the second wall portion 303 can comprise a stainless steel material, or an Inconel material, and the first wall portion 301 can comprise a silicon carbide material. While several types of materials are envisioned for the first wall portion 301 and the second wall portion 303, the first wall portion 301 can comprise a material with a higher thermal conductivity than the thermal conductivity of the second wall portion 303. In this way, the first surface characteristic 217 can comprise a first thermal conductivity and the second surface characteristic 218 can comprise a second thermal conductivity, with the first thermal conductivity greater than the second thermal conductivity. The differing materials, along with the first wall thickness 313 being less than the second wall thickness 315, can cause a differing rate of heat transfer for portions of the ribbon 123 that are in contact with the first surface 305 as compared to portions of the ribbon 123 that are in contact with the second surface 307. For example, due to the first wall portion 301 comprising a higher thermal conductivity than the second wall portion 303, a greater amount of heat may be extracted from the portion of the ribbon 123 in contact with the first surface 305 than the portion of the ribbon 123 in contact with the second surface 307. For example, the protrusion 125 lies within the recess 115 and is in contact with the first surface 305, and a ribbon portion of the ribbon 123 surrounding the protrusion 125 may be in contact with the second surface 307. Due to the surface characteristics of the first forming roll 107 (e.g., the difference in material thermal conductivity), during a cooling period of time, the first surface 305 can cool at a faster rate than the second surface 307. The cooling period of time can comprise the period of time during which the molten glass 103 is in contact with the wall 205 and the ribbon 123 is formed. In aspects, to further reduce a thermal conductivity of the second wall portion 303, the second surface 307 and/or the third surface 221 may be coated with a material comprising a lower thermal conductivity than stainless steel material, or an Inconel material. In this way, the ribbon portion of the ribbon 123 in contact with the second surface 307 may be cooled at a slower rate than the protrusion 125 in contact with the first surface 305.

FIGS. 4-7 illustrate additional methods for cooling the protrusion 125 at a location downstream from the forming rolls 107, 109. For example, referring to FIG. 4, the glass manufacturing apparatus 100 can comprise the cooling apparatus 141 (e.g., illustrated in FIG. 1) positioned downstream from the forming rolls 107, 109 and adjacent to the ribbon 123. In aspects, the cooling apparatus 141 can comprise a cooling mechanism 401 that can cool the protrusion 125 such that, during a cooling period of time, the protrusion 125 can be cooled at a faster rate than a ribbon portion 403 of the ribbon 123. The ribbon portion 403 can comprise the area surrounding the protrusion 125 and can comprise a thinner portion of the ribbon 123 while the protrusion 125 can comprise a thicker portion of the ribbon 123. In aspects, the cooling apparatus 141 can comprise a dispenser 405 and the cooling mechanism 401 can comprise one or more of air or an aerosol directed from the dispenser 405 toward the protrusion 125. In aspects, when the cooling mechanism 401 comprises air, the dispenser 405 may be in fluid communication with a gas source, such as, for example, a pump, a cannister, a cartridge, a boiler, a compressor, a pressure vessel, etc. The gas source can deliver compressed air (e.g., air kept under a pressure that is greater than atmospheric pressure) to the dispenser 405, whereupon, the dispenser 405 can direct the air (e.g., the cooling mechanism 401) toward the protrusion 125. In aspects, when the cooling mechanism 401 comprises an aerosol, the dispenser 405 may be in fluid communication with a fluid source that can deliver a fluid (e.g., water) to the dispenser 405 and a gas source that can deliver compressed air to the dispenser 405. The gas and fluid can be delivered to the dispenser 405 and mixed, whereupon, the dispenser 405 can deliver an aerosol. The aerosol can comprise, for example, a suspension of liquid droplets in air in the form of a mist or water spray.

In aspects, the dispenser 405 may be coupled to a control apparatus that can control the timing of when the dispenser 405 delivers the cooling mechanism 401 to the protrusion 125. For example, when the protrusion 125 is adjacent to the dispenser 405 (e.g., by lying within a field of view of the dispenser 405 such that cooling mechanism 401 delivered from the dispenser 405 will impinge upon the protrusion 125), the control apparatus can direct the dispenser 405 to deliver the cooling mechanism 401 toward the protrusion 125. In this way, the cooling mechanism 401 can impinge upon the protrusion 125 and reduce a temperature of the protrusion 125 while not impinging upon the ribbon portion 403. As such, the protrusion 125 can be cooled at a faster rate than the ribbon portion 403. In aspects, the rate of cooling of the protrusion 125 can be increased by adjusting the cooling mechanism 401, for example, flow rate characteristics of the air or aerosol. For example, to increase the rate of cooling, one or more of a velocity of the air or aerosol can be increased, a temperature of the air or aerosol can be decreased, and/or a particle size of the liquid droplets of the aerosol can be adjusted.

FIG. 5 illustrates the ribbon 123 after a period of time has passed and the ribbon 123 has moved in the first travel direction 117. In aspects, as the ribbon 123 moves in the first travel direction 117, the ribbon portion 403 may move adjacent to the dispenser 405 (e.g., within the field of view of the dispenser 405) and the protrusion 125 may move away from the dispenser 405. The control apparatus can direct the dispenser 405 to stop delivering the cooling mechanism 401 toward the protrusion 125 as the ribbon portion 403 passes the dispenser 405. In this way, the dispenser 405 may not deliver the cooling mechanism 401 toward the ribbon portion 403 and, thus, not providing additional cooling to the ribbon portion 403 (e.g., as indicated by the lack of arrows for the cooling mechanism 401). After a period of time passes and the ribbon portion 403 has passed the dispenser 405, another protrusion may pass the dispenser 405, whereupon the control apparatus can cause the dispenser 405 to deliver the cooling mechanism 401 toward the protrusion. The dispenser 405 can be controlled in several ways. For example, for protrusions that are not continuous (e.g., by extending perpendicular to the first travel direction 117 across the ribbon 123), the dispenser 405 may cycle between an on position (e.g., in which the dispenser 405 dispenses the cooling mechanism 401 toward the ribbon 123) and an off position (e.g., in which the dispenser 405 stops dispensing the cooling mechanism 401). For protrusions that are continuous (e.g., by extending parallel to the first travel direction 117 along a length of the ribbon 123), the cooling mechanism 401 can be aligned with the protrusion and may remain in the on position to continuously deliver the cooling mechanism 401 toward the protrusion.

In aspects, the on and off positions can be synchronized to a timer that is correlated to a position of the protrusions 125 and the ribbon portions 403 based on a speed at which the ribbon 123 is moving. For example, when the ribbon 123 is traveling at a constant speed, then a control apparatus can determine when the protrusions 125 and the ribbon portions 403 pass the dispenser 405. In aspects, the on and off positions may not rely on a timer, but, rather, a visual inspection system can determine the presence of the protrusions 125 relative to the dispenser 405. For example, a camera can be positioned to monitor when the protrusions 125 and the ribbon portions 403 pass the dispenser 405, and, based on these positions, can trigger the dispenser 405 to dispense the cooling mechanism 401 or not. Accordingly, in aspects, methods can comprise reducing a temperature difference between the protrusion 125 and the ribbon portion 403 by directing a material (e.g., the air or aerosol of the first cooling mechanism 401) toward the protrusion 125 to cool the protrusion 125, with the directing occurring at a location downstream from the imparting of the protrusion 125 (e.g., at the forming rolls 107, 109). In aspects, while the dispenser 405 is illustrated as being substantially stationary relative to the ribbon 123, in aspects, the dispenser 405 can move with the ribbon 123 in the first travel direction 117, for example, with the dispenser 405 positioned over the protrusion 125 and delivering the cooling mechanism 401 to the protrusion 125 as the dispenser 405 moves at the same speed as the ribbon 123 in the first travel direction 117.

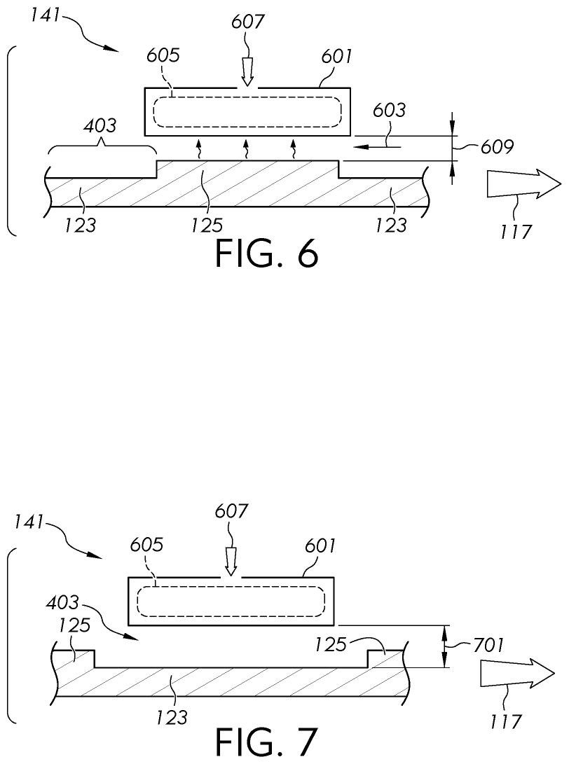

FIG. 6 illustrates additional aspects of the cooling apparatus 141. For example, the cooling apparatus 141 can comprise a plate 601 comprising a hollow chamber 605 within which a cooling liquid 607 is stored, with the plate 601 positioned adjacent to the protrusion 125. The plate 601 can comprise a cooling mechanism 603 that can cool the protrusion 125 such that, during a cooling period of time, the protrusion 125 can be cooled at a faster rate than a ribbon portion 403 of the ribbon 123. In aspects, the cooling mechanism 603 can comprise convection, or convective heat transfer, in which heat can be dissipated from the protrusion 125 to the plate 601 due to the plate 601 being at a lower temperature than the protrusion 125. In aspects, a first distance 609 can separate the protrusion 125 and the plate 601 with the first distance 609 less than about 0.1 millimeters (mm), for example. In aspects, the plate 601 may be stationary relative to the ribbon 123 such that the ribbon 123 can move in the first travel direction 117 while the plate 601 remains stationary. Accordingly, as the protrusion 125 passes the plate 601, the protrusion 125 may be cooled due to the plate 601 and the protrusion 125 being in close contact (e.g., the first distance 609) and due to the plate 601 being at a lower temperature than the protrusion 125 as a result of the cooling liquid 607. In aspects, the plate 601 can comprise a graphite material.

FIG. 7 illustrates the ribbon 123 after a period of time has passed and the ribbon 123 has moved in the first travel direction 117. In aspects, as the ribbon 123 moves in the first travel direction 117, the ribbon portion 403 may move past the plate 601 and the protrusion 125 may move away from the plate 601. In aspects, a second distance 701 can separate the ribbon portion 403 and the plate 601, with the second distance 701 greater than the first distance 609. In aspects, the second distance 701 may be within a range from about 0.5 mm to about 5 mm. Due to the second distance 701 being larger than the first distance 609, the plate 601 may produce a greater temperature reduction and heat extraction from the protrusion 125 than from the ribbon portion 403. In this way, reducing the temperature difference between the protrusion 125 and the ribbon portion 403 can comprise positioning the plate 601 adjacent to the ribbon 123 such that the first distance 609 separating the plate 601 and the protrusion 125 is less than the second distance 701 separating the plate 601 and the ribbon portion 403.

While FIG. 7 illustrates one plate 601 positioned facing the protrusion 125, in aspects, one or more plates may be positioned on an opposite side of the ribbon 123 to provide additional cooling. For example, one or more plates (e.g., substantially identical to the plate 601) may be positioned opposite the plate 601 in proximity to the ribbon 123, thus cooling the protrusion 125. In addition, or in the alternative, while the plate 601 is illustrated as being substantially stationary relative to the ribbon 123, in aspects, the plate 601 can move with the ribbon 123 in the first travel direction 117. While moving with the ribbon 123, the plate 601 may not be in contact with the protrusion 125 and spaced the first distance 609 from the protrusion 125, or, alternatively, the plate 601 may contact the protrusion 125 such that the first distance 609 may be zero. In these aspects, by moving with the ribbon 123, the plate 601 can increase the time at which the plate 601 is adjacent to the protrusion 125, thus increasing the amount of heat extracted from the protrusion 125.

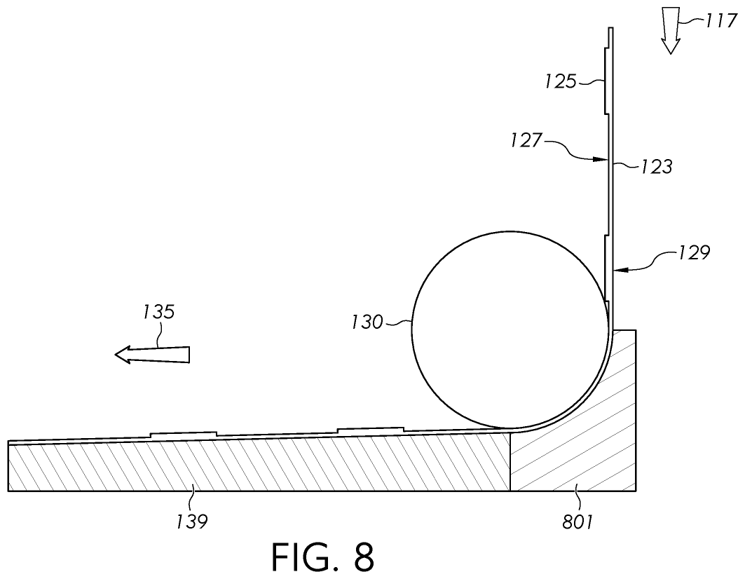

FIG. 8 illustrates aspects of the turning roll 130, positioned downstream from the cooling apparatus 141, and the support surface 139. In aspects, the support surface 139 can be positioned downstream from the turning roll 130, with the support surface 139 configured to support the ribbon 123. The turning roll 130 can be spaced apart from a body 801 with a gap formed between the body 801 and the turning roll 130. In aspects, the body 801 can comprise a curved surface that can substantially match a shape of the turning roll 130 such that, as the ribbon 123 passes between the body 801 and the turning roll 130, the ribbon 123 may be directed to move in a direction and along a travel path that is different from the first travel direction 117. To maintain the ribbon 123 in contact with the turning roll 130, the body 801 can apply a force to the ribbon 123 to bias the ribbon 123 toward the turning roll 130. In aspects, a gas can be emitted from the body 801 through one or more openings, with the gas directed toward the ribbon 123 to bias the ribbon 123 toward the turning roll 130. In this way, the ribbon 123 may be spaced apart from, and not come into contact with, the body 801 while providing support to the second major surface 129 of the ribbon 123 and mitigating sagging at locations of the ribbon 123 comprising the protrusion 125. In aspects, the turning roll 130 can comprise one or more of a stainless steel material, an Inconel material, a graphite material, a silica material, etc. The turning roll 130 may comprise a substantially flat outer radial surface, or may comprise one or more grooves that match the location of the protrusions 125. In the alternative, the turning roll 130 can comprise an air bearing.

In aspects, the support surface 139 can be positioned downstream from the turning roll 130 and the body 801, such that the ribbon 123 can pass from the turning roll 130 and the body 801 to the support surface 139. In aspects, the support surface 139 can comprise an air bearing, such that air can be pass through openings in the support surface 139 to impinge upon the second major surface 129 and support the ribbon 123 in a spaced apart configuration from the support surface 139. In addition, or in the alternative, the support surface 139 can comprise one or more rollers that can support and convey the ribbon 123. In aspects, to provide additional support to the ribbon 123, the support surface 139 can comprise a planar or non-planar shape. For example, the support surface 139 can be contoured and may comprise one or more raised surfaces (e.g., one or both of across the ribbon 123 perpendicular to the travel direction 135 of the ribbon 123 or along the ribbon 123 parallel to the travel direction 135 of the ribbon 123). In aspects, the one or more raised surfaces can be positioned to match the locations of the protrusions 125. In aspects, the support surface 139 is not limited to a stationary surface, and, for example, can comprise a moving structure (e.g., a series of molds with a flat top) that move with the ribbon 123.

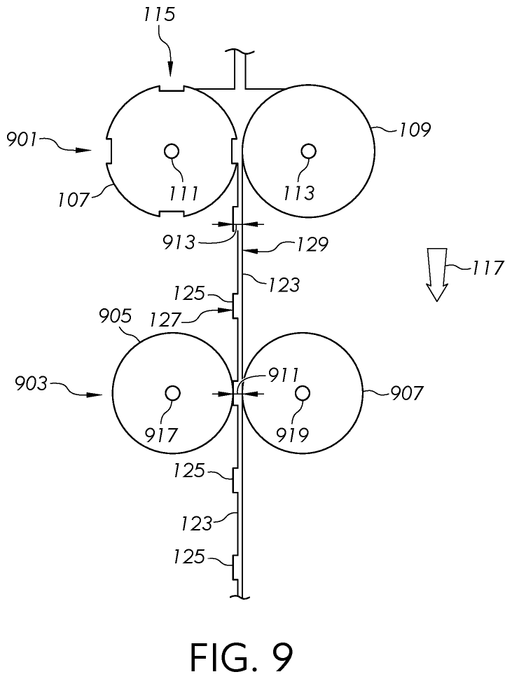

FIGS. 9-11 illustrate additional aspects of cooling the protrusion 125 in which the glass manufacturing apparatus 100 is not limited to comprising two forming rolls (e.g., the first forming roll 107 and the second forming roll 109) but may comprise more than two forming rolls. For example, referring to FIG. 9, the glass manufacturing apparatus 100 can comprise a first set 901 of forming rolls, (e.g., the first forming roll 107 and the second forming roll 109), and a second set 903 of forming rolls, for example, a third forming roll 905 and a fourth forming roll 907. The second set 903 of forming rolls may be positioned downstream from the first set 901 of forming rolls. As such, the third forming roll 905 can be downstream from the first forming roll 107, with the first forming roll 107 and the third forming roll 905 positioned on the same side of the ribbon 123. The fourth forming roll 907 can be downstream from the second forming roll 109, with the second forming roll 109 and the fourth forming roll 907 positioned on the same side of the ribbon 123 opposite the first forming roll 107 and the third forming roll 905. The third forming roll 905 and the fourth forming roll 907 can rotate counter to one another, for example, with the first forming roll 107 and the third forming roll 905 rotating in the same direction (e.g., a clockwise direction), and the second forming roll 109 and the fourth forming roll 907 rotating in the same direction (e.g., a counter-clockwise direction). In aspects, the fourth forming roll 907 can be cooled such that the fourth forming roll 907 can cool the protrusion 125 from the side of the second major surface 129.

The first forming roll 107 can form the protrusion 125 in a similar manner as described relative to FIG. 1. In aspects, the third forming roll 905 and the fourth forming roll 907 can be spaced a first separating distance 911. The ribbon 123 can comprise a protrusion thickness 913 at the protrusion 125 at a location downstream from the first set 901 of forming rolls and upstream from the second set 903 of forming rolls. The protrusion thickness 913 is the distance between the second major surface 129 and the first major surface 127 at the protrusion 125. In aspects, the separating distance 911 may be less than or equal to the protrusion thickness 913, with the separating distance 911 equal to a desired protrusion thickness at a location downstream from the second set 903 of forming rolls. For example, in aspects, the separating distance 911 may be substantially equal to the protrusion thickness 913 such that, as the protrusion 125 moves in the first travel direction 117 toward the second set 903 of forming rolls, the protrusion 125 may pass between the third forming roll 905 and the fourth forming roll 907, with the third forming roll 905 contacting the first major surface 127 at the protrusion 125. The third forming roll 905 can be substantially hollow and cooled with a fluid (e.g., similar to FIGS. 2-3), such that contact between the protrusion 125 and the third forming roll 905 can cause heat to be extracted from the protrusion 125, thus cooling the protrusion 125.

In aspects, the separating distance 911 may be less than the protrusion thickness 913 such that, as the protrusion 125 moves in the first travel direction 117 toward the second set 903 of forming rolls, the protrusion 125 may pass between the third forming roll 905 and the fourth forming roll 907, with the third forming roll 905 contacting the first major surface 127 at the protrusion 125. Due to the separating distance 911 being less than the protrusion thickness 913, the third forming roll 905 can contact the protrusion 125 and apply a force to the protrusion 125. The fourth forming roll 907 can apply a counter-force to the second major surface 129, thus reducing the protrusion thickness 913 of the protrusion 125 and planarizing the protrusion 125 as the protrusion 125 passes between the third forming roll 905 and the fourth forming roll 907. The contact between the protrusion 125 and the third forming roll 905 can cause heat to be extracted from the protrusion 125, thus cooling the protrusion 125. Accordingly, in this way, one or more forming rolls (e.g., the third forming roll 905 and the fourth forming roll 907) can be positioned downstream from the forming rolls 107, 109, with the forming rolls 905, 907 configured to cool the ribbon 123 and flatten the protrusion 125.

In aspects, the second set 903 of forming rolls may be aligned with the first set 901 of forming rolls. By being aligned, a plane can intersect the first axis 111 and a third axis 917 of the third forming roll 905 about which the third forming roll 905 rotates, with the plane substantially parallel to the ribbon 123 and the major surfaces 127, 129. Likewise, by being aligned, a plane can intersect the second axis 113 and a fourth axis 919 of the fourth forming roll 907 about which the fourth forming roll 907 rotates, with the plane substantially parallel to the ribbon 123 and the major surfaces 127, 129. In this way, contact between the second major surface 129 and the fourth forming roll 907 can be minimized and may occur only when the third forming roll 905 contacts and applies a force to the protrusion 125. In aspects, however, the second set 903 of forming rolls may be misaligned with the first set 901 of forming rolls. By being misaligned, the plane intersecting the axes 111, 917 may be non-parallel to the ribbon 123 and the major surfaces 127, 129, and the plane intersecting the axes 113, 919 may be non-parallel to the ribbon 123 and the major surfaces 127, 129. In this way, the ribbon 123 may contact the second set 903 of forming rolls and may be redirected, thus increasing the amount of time that the ribbon 123 is in contact with the third forming roll 905, which can increase the heat extraction from the protrusion 125.

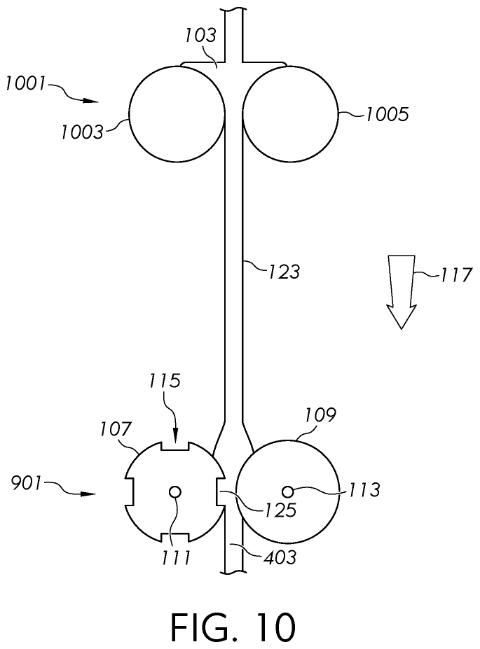

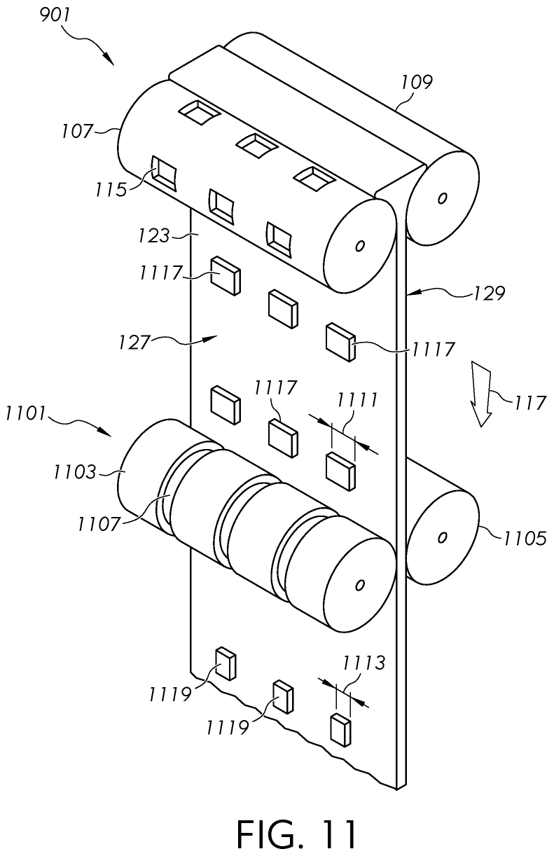

Referring to FIG. 10, the glass manufacturing apparatus 100 can comprise the first set 901 of forming rolls and a second set 1001 of forming rolls, for example, a third forming roll 1003 and a fourth forming roll 1005. The second set 1001 of forming rolls may be positioned upstream from the first set 901 of forming rolls. As such, the third forming roll 1003 can be upstream from the first forming roll 107, with the first forming roll 107 and the third forming roll 1003 positioned on the same side of the ribbon 123. The fourth forming roll 1005 can be upstream from the second forming roll 109, with the second forming roll 109 and the fourth forming roll 1005 positioned on the same side of the ribbon 123 opposite the first forming roll 107 and the third forming roll 1003. The third forming roll 1003 and the fourth forming roll 1005 can rotate counter to one another. In aspects, as with the alignment of the second set 903 of forming rolls described above relative to FIG. 9, the forming rolls 1003, 1005 may be aligned or misaligned with the rollers 107, 109.

In aspects, the third forming roll 1003 and/or the fourth forming roll 1005 can be substantially hollow and cooled with a fluid (e.g., similar to FIGS. 2-3), such that contact between the stream of molten glass 103 and the third forming roll 1003 can reduce a temperature of the molten glass 103 and, thus, the ribbon 123. In aspects, the stream of molten glass 103 can accumulate between the third forming roll 1003 and the fourth forming roll 1005, whereupon the third forming roll 1003 and the fourth forming roll 1005 can flatten, thin, and smooth the stream of molten glass 103 into the ribbon 123. The third forming roll 1003 and the fourth forming roll 1005 may not comprise recesses, such that the ribbon 123 exiting the gap between the third forming roll 1003 and the fourth forming roll 1005 may not comprise protrusions, but, rather, may comprise a substantially constant thickness. The ribbon 123 can then pass through the gap between the first forming roll 107 and the second forming roll 109, such that the protrusion 125 can be formed in a similar manner as described relative to FIG. 1. In this way, the ribbon 123 can be cooled (e.g., by the second set 1001 of forming rolls) prior to reaching the first set 901 of forming rolls. As such, by pre-cooling the ribbon, a temperature difference between the protrusion 125 and the ribbon portion 403 may be reduced. In aspects, and as explained above, the terms “first” and “second” are not intended to imply an ordering, but rather, are merely used as identifiers, such that the first set 901 may be downstream from the second set 1001.

Referring to FIG. 11, the glass manufacturing apparatus 100 can comprise the first set 901 of forming rolls, and a second set 1101 of forming rolls, for example, a third forming roll 1103 and a fourth forming roll 1105. The second set 1101 of forming rolls may be positioned downstream from the first set 901 of forming rolls. As such, the third forming roll 1103 can be downstream from the first forming roll 107, with the first forming roll 107 and the third forming roll 905 positioned on the same side of the ribbon 123. The fourth forming roll 1105 can be downstream from the second forming roll 109, with the second forming roll 109 and the fourth forming roll 1105 positioned on the same side of the ribbon 123 opposite the first forming roll 107 and the third forming roll 1103. The third forming roll 1103 and the fourth forming roll 1105 can rotate counter to one another. In aspects, as with the alignment of the second set 903 of forming rolls described above relative to FIG. 9 and the alignment or misalignment of FIG. 10, the forming rolls 1103, 1105 may be aligned or misaligned with the rollers 107, 109.

The first forming roll 107 can form an initial protrusion 1117 in a similar manner as described relative to FIG. 1. The initial protrusion 1117 can comprise a first width 1111 measured in a direction substantially perpendicular to the first travel direction 117. The ribbon 123 may continue to move in the first travel direction 117 and may pass between the third forming roll 1103 and the fourth forming roll 1105. In aspects, the third forming roll 1103 can comprise one or more recesses 1107 that may be aligned with the initial protrusions 1117. By being aligned, an axis can intersect one of the initial protrusion 1117 and one of the recesses 1107, with the axis substantially parallel to the first travel direction 117. In this way, as the ribbon 123 passes between the third forming roll 1103 and the fourth forming roll 1105, the initial protrusions 1117 may be received within the recesses 1107. In aspects, the recesses 1107 may extend circumferentially around an outer radial surface of the third forming roll 1103.

The recesses 1107 can comprise a second width 1113 that is less than the first width 1111 of the initial protrusion 1117, such that the initial protrusion 1117 may be wider than the recess 1107. As such, upon being received within the recess 1107, the initial protrusion 1117 may be reformed and reduced in size, such that a portion of the glass may be redistributed. The initial protrusion 1117 may therefore be reformed and resized to a final protrusion 1119. For example, after exiting the recess 1107 and moving downstream from the second set 1101 of forming rolls, the final protrusion 1119 may comprise the second width 1113, such that the final protrusion 1119 may comprise a width that is less than the initial protrusion 1117. In addition, or in the alternative, the recess 1107 may comprise a different depth than the recess 115, such that the initial protrusion 1117 may comprise a different thickness than the final protrusion 1119. In aspects, the recess 115 may comprise a greater depth than the recess 1107 such that an initial thickness of the initial protrusion 1117 may be greater than a final thickness of the final protrusion 1119. Accordingly, the third forming roll 1103 can modify the width and/or the thickness of the initial protrusion 1117, for example, by reducing a size (e.g., the width and the thickness) of the initial protrusion 1117 during formation of the final protrusion 1119. In aspects, the first forming roll 107 and the third forming roll 1103 may be cooled, for example, by being substantially hollow and filled with a cooling fluid.

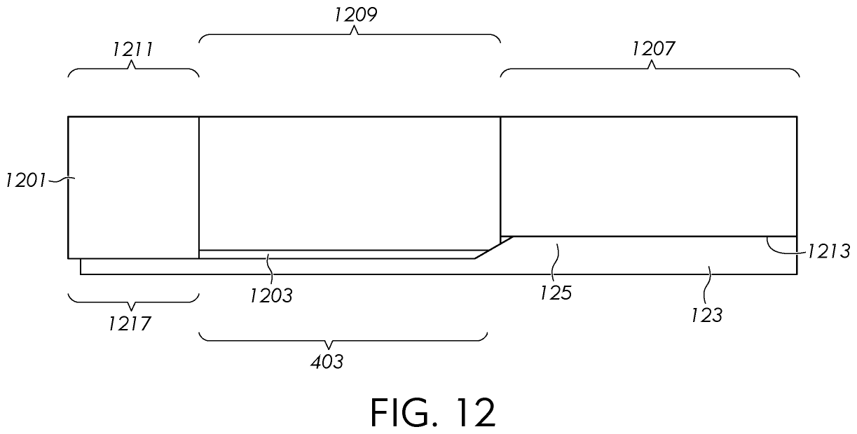

FIG. 12 illustrates an enlarged view of the ribbon 123 contacting a roll 1201. In aspects, the roll 1201 can be substantially similar to one or more of the rolls comprising a recess described above (e.g., one or more of forming rolls 107, 1103, for example). In aspects, when the roll 1201 is in contact with the ribbon 123, the roll 1201 may define a gap 1203 between the ribbon portion 403 and the roll 1201. For example, the roll 1201 can comprise a first roll portion 1207, a second roll portion 1209, and a third roll portion 1211. The first roll portion 1207 can comprise a recess 1213 (e.g., similar to one or more of the recesses 115, 1107) within which the protrusion 125 can be received. The roll 1201 may comprise a second roll portion 1209 attached to the first roll portion 1207. The second roll portion 1209 may comprise the area (e.g., substantially identical to the area 215 of FIGS. 2-3) surrounding the recess 1213. The roll 1201 may comprise a third roll portion 1211 attached to the second roll portion 1209.

In aspects, the roll 1201 may contact some, but not all, of the ribbon 123. For example, the protrusion 125 may be received within the recess 1213 and may be in contact with the first roll portion 1207. The ribbon 123 may comprise an edge area 1217 in contact with the third roll portion 1211. In aspects, the edge area 1217 can comprise a non-quality portion of the ribbon 123. In aspects, the ribbon portion 403 surrounding the protrusion 125 may not be in contact with the roll 1201. Rather, the gap 1203 may be formed between the ribbon portion 403 and the second roll portion 1209, such that the ribbon portion 403 may not be contacted while the surrounding portions of the ribbon 123, for example, the protrusion 125 and the edge area 1217, may contact the roll 1201. The ribbon portion 403 may comprise a quality area of the ribbon 123, such that by avoiding contact with the roll 1201, surface quality of the ribbon portion 403 may be maintained. In aspects, while the previous description relative to FIGS. 9-11 is related to rolling operations in two stages, additional stages (e.g., three stages, or three sets of rollers, four stages, or four sets of rollers, or more, etc.) of rollers are possible. For example, in FIG. 9, additional rollers which may be substantially identical to the rollers 905, 907 may be positioned downstream from the rollers 905, 907. Likewise, in FIG. 10, additional rollers which may be substantially identical to the rollers 1003, 1005 may be positioned upstream and/or downstream from the rollers 1003, 1005. Further, the roller configurations of FIGS. 9 and 10 can also be combined, for example, with the rollers 1003, 1005 at an upstream location, rollers 107, 109 downstream from the rollers 1003, 1005, and rollers 905, 907 downstream from the rollers 107, 109.

FIGS. 13-15 illustrate several shapes of protrusions that can be formed. For example, referring to FIG. 13, the protrusions 125 can comprise a quadrilateral shape (e.g., square, rectangle, etc.). The protrusions 125 comprising the quadrilateral shape comprise a width in a direction substantially perpendicular to the first travel direction 117 and a length substantially parallel to the first travel direction 117. In aspects, the protrusions 125 can comprise a width within a range from about 10 mm to about 50 mm and a length within a range from about 10 mm to about 50 mm. The ribbon 123 can comprise a thickness at the ribbon portion 403 that is within a range from about 0.5 mm to about 2 mm, or less than about 0.8 mm, and a thickness at the protrusion that is within a range from about 1 mm to about 5 mm, or within a range from about 1.5 mm to about 3 mm. In aspects, at the transition between the ribbon portion 403 and the protrusion 125, a wall angle may be less than about 90 degrees. Referring to FIG. 14, the protrusions 125 can comprise an elongated, continuous shape along the length of the ribbon 123 substantially parallel to the first travel direction 117. In aspects, the protrusions 125 can comprise a width (e.g., substantially perpendicular to the first travel direction 117) that is within a range from about 10 mm to about 100 mm, and a length that is from about 280 mm to a continuous length. Referring to FIG. 15, the protrusions 125 can comprise an elongated, continuous shape along the width of the ribbon 123 substantially perpendicular to the first travel direction 117. In aspects, the protrusions 125 can comprise a width (e.g., substantially perpendicular to the first travel direction 117) that is within a range from about 200 mm to about 400 mm, and a length (e.g., substantially parallel to the first travel direction 117) that is from about 10 mm to about 50 mm.

The aforementioned methods of manufacturing the ribbon 123 can yield several benefits. For example, methods can comprise reducing a temperature difference between the protrusion 125 and the ribbon portion 403 of the ribbon 123 surrounding the protrusion 125. In aspects, the temperature difference can arise from the formation of the protrusion 125 by the forming rolls 107, 109, with the protrusion 125 comprising a greater mass and higher temperature than the ribbon portion 403. The temperature difference can be reduced in several ways, for example by cooling the protrusion 125 at a faster rate than cooling the ribbon portion 403. In aspects, reducing the temperature difference can occur as the protrusion 125 is imparted and the ribbon 123 contacts the forming rolls 107, 109. For example, as illustrated in FIGS. 2-3, the ribbon 123 can contact the wall 205 of the first forming roll 107, and the first forming roll 107 can comprise the surface characteristics 217, 218 that can reduce the temperature of the protrusion 125 relative to the temperature of the ribbon portion 403.

In aspects, methods can comprise cooling the first forming roll 107 by delivering the liquid 203 to the hollow chamber 201 of the first forming roll 107, thus cooling the wall 205 and the protrusion 125. Due to the reduced wall thickness at the recess 115 (e.g., illustrated in FIG. 2) and/or the material comprising a higher thermal conductivity (e.g., illustrated in FIG. 3) and/or the different surface roughness at the recess 115, heat extraction at the recess of the first forming roll 107 may be greater than at a different location (e.g., at the second surfaces 211, 307) of the first forming roll 107. By reducing a temperature difference between a thick portion (e.g., at the protrusion 125) and a thin portion (e.g., at the ribbon portion 403) of the ribbon 123, several negative effects can be minimized and/or avoided. For example, back-protrusion of the protrusions 125, in which a major surface of the ribbon 123 sags due to the weight of the protrusion 125, can be reduced. Likewise, deformation of the ribbon 123 may also be avoided. In aspects, excess stress and warpage of the ribbon 123, which may be associated with a temperature differential between the thick and thin portions of the ribbon 123, can be limited, thus maintaining the stress and warpage within a desirable range.

It should be understood that while various aspects have been described in detail relative to certain illustrative and specific examples thereof, the present disclosure should not be considered limited to such, as numerous modifications and combinations of the disclosed features are possible without departing from the scope of the following claims.

1. A glass manufacturing apparatus comprising:
a delivery apparatus defining an upstream portion of a ribbon travel path extending in a first travel direction;
a forming roll extending along an axis that is parallel to the travel path and perpendicular to the first travel direction, the forming roll comprising a recess configured to impart a protrusion to a ribbon traveling along the ribbon travel path in the first travel direction, the forming roll comprising:
a first surface defining the recess and comprising a first surface characteristic;
a second surface defining an area surrounding the recess and comprising a second surface characteristic, the first surface characteristic different than the second surface characteristic wherein, during a cooling period of time, the first surface is configured to cool at a faster rate than the second surface.

2. The glass manufacturing apparatus of claim 1, wherein the first surface characteristic comprises a first surface roughness and the second surface characteristic comprises a second surface roughness, the first surface roughness less than the second surface roughness.

3. The glass manufacturing apparatus of claim 2, wherein the first surface characteristic comprises a third surface roughness different from the first surface roughness.

4. The glass manufacturing apparatus of claim 1, wherein the forming roll is hollow and the first surface characteristic comprises a first wall thickness and the second surface characteristic comprises a second wall thickness, the first wall thickness less than the second wall thickness.

5. The glass manufacturing apparatus of claim 1, wherein the first surface characteristic comprises a first thermal conductivity and the second surface characteristic comprises a second thermal conductivity, the first thermal conductivity greater than the second thermal conductivity.

6. The glass manufacturing apparatus of claim 1, wherein the forming roll comprises a hollow chamber comprising a liquid.

7. The glass manufacturing apparatus of claim 1, further comprising a cooling apparatus comprising a cooling mechanism to cool the protrusion, the cooling apparatus comprising a dispenser, and the cooling mechanism comprising one or more of air or an aerosol directed from the dispenser toward the protrusion.

8. The glass manufacturing apparatus of claim 1, further comprising a second forming roll positioned one of downstream or upstream from the forming roll, the second forming roll configured to cool the ribbon and flatten the protrusion.

9. A glass manufacturing apparatus comprising:
a delivery apparatus defining an upstream portion of a ribbon travel path extending in a first travel direction;
a forming roll extending along an axis that is parallel to the travel path and perpendicular to the first travel direction, the forming roll comprising a recess configured to impart a protrusion to a ribbon traveling along the ribbon travel path in the first travel direction;
a turning roll downstream from the forming roll and extending along an axis that is parallel to the travel path, the turning roll configured to direct the ribbon along the ribbon travel path in a second travel direction that is non-parallel to the first travel direction; and
a cooling apparatus positioned downstream from the forming roll and upstream from the turning roll, the cooling apparatus comprising a cooling mechanism to cool the protrusion, and wherein, during a cooling period of time, the protrusion is configured to cool at a faster rate than a ribbon portion of the ribbon surrounding the protrusion.

10. The glass manufacturing apparatus of claim 9, wherein the forming roll comprises a first surface defining the recess and comprising a first surface characteristic, and a second surface defining an area surrounding the recess and comprising a second surface characteristic, the first surface characteristic different than the second surface characteristic wherein, during the cooling period of time, the first surface is configured to cool at a faster rate than the second surface.

11. The glass manufacturing apparatus of claim 9, wherein the cooling apparatus comprises a dispenser, and the cooling mechanism comprises one or more of air or an aerosol directed from the dispenser toward the protrusion.

12. The glass manufacturing apparatus of claim 9, wherein the cooling apparatus comprises a plate comprising a hollow chamber within which a liquid is stored, the plate positioned adjacent to the protrusion.

13. The glass manufacturing apparatus of claim 12, wherein the cooling mechanism comprises a first surface portion of the plate in contact with the protrusion.

14. The glass manufacturing apparatus of claim 9, further comprising a support surface positioned downstream from the turning roll, the support surface configured to support the ribbon, the support surface comprising a non-planar shape.

15. The glass manufacturing apparatus of claim 9, further comprising a second forming roll positioned one of downstream or upstream from the forming roll, the second forming roll configured to cool the ribbon and flatten the protrusion.

16. A method of manufacturing a ribbon comprising:
contacting the ribbon with a recess of a forming roll to impart a protrusion to the ribbon traveling along a ribbon travel path in a first travel direction;
reducing a temperature difference between the protrusion and a ribbon portion of the ribbon surrounding the protrusion.

17. The method of claim 16, wherein the reducing the temperature difference comprises cooling the protrusion at a faster rate than cooling the ribbon portion.

18. The method of claim 17, wherein the reducing the temperature difference comprises directing a material toward the protrusion to cool the protrusion, the directing occurring at a location downstream from the imparting of the protrusion.

19. The method of claim 17, wherein the reducing the temperature occurs as the protrusion is imparted and the ribbon contacts the forming roll.

20. The method of claim 19, further comprising cooling the forming roll by providing a liquid to a hollow chamber of the forming roll.
